(19) United States
(12) Patent Application Publication
(10) Pub. No.: US 2015/0106243 A1
(43) Pub. Date: Apr. 16, 2015

(54) AGGREGATION OF ITEM-LEVEL TRANSACTION DATA FOR A GROUP OF INDIVIDUALS

(71) Applicant: Bank of America Corporation, Charlotte, NC (US)

(72) Inventors: Jason P. Blackhurst, Charlotte, NC (US); Laura C. Bondesen, Charlotte, NC (US); Matthew A. Calman, Charlotte, NC (US); Katherine Dintenfass, Charlotte, NC (US); Carrie Anne Hanson, Charlotte, NC (US)

(73) Assignee: Bank of America Corporation, Charlotte, NC (US)

(21) Appl. No.: 14/052,334

(22) Filed: Oct. 11, 2013

(51) Int. Cl. G06Q 40/00

(52) U.S. Cl. CPC G06Q 40/12
USPC 705/30

(57) ABSTRACT

Apparatus, methods, and computer program products are provided for that automatically identify transactions and/or items in a transaction that are associated with a group of individuals, such as a family, co-workers, a special interest group, a demographic group a social network group or the like. Once transactions and/or items in the transaction have been identified as being associated with the group, the transaction data associated with the transactions and/or the items in the transactions is aggregated and aggregated views of the data are made accessible to individuals in the group, such as through a financial institution financial management application, e.g., online or mobile banking application.

### FIELD

In general, embodiments of the invention relate to methods, systems, apparatus and computer program products for financial transaction management and, more particularly, for determining, through the use of structured transaction item-identifying data that transactions or items in the transactions are associated with a designated group of individuals, aggregating the item-identifying data associated with the designated group of individuals at an item-level or a transaction-level and providing individuals in the group access to the aggregated item-identifying data.

### BACKGROUND

There has been recent growth in personal finance management applications, such as online banking, mobile banking and the like, whereby financial institution customers, (such as bank and credit card customers), may view financial account transaction data, perform online payments and money transfers, view account balances, and the like. Many current online banking applications are fairly robust and provide customers with budgeting tools, financial calculators, and the like to assist the customer to not only perform and view financial transaction date, but also to manage finances. A current drawback with online banking is that transactional level detail for a given purchase by the customer is limited. Despite the large amount of information sent by merchants to customers regarding purchases, merchants currently do not provide purchase details to financial institutions. The only information provided by the merchant to the financial institution is information about the merchant and an overall transaction amount. For example, if a financial institution customer purchases several clothing items from a merchant and uses a financial institution debit card, credit card or check, all that is provided to the financial institution is the merchant information and overall purchase amount. Product level detail that is present on the receipt provided to the customer by the merchant is not provided to the financial institution.

The lack of detailed information regarding a given transaction in the online or mobile banking environment limits a customer's ability to ascertain a larger picture of purchase history and financial transaction information. This is especially true for groups of individuals, such as families, co-workers within a small business, special interest groups, demographic groups, social network groups or the like. Unless the individuals that comprise the group all use the same payment account or a linked payment account to purchase items, individuals in the group are unable to readily ascertain what transactions or relevant items or services have been purchased by the group. The only known means by which such group purchasing history is consolidated is by manual identification of transactions associated with the group or specific items or services associated with the group and, once identifying, forwarded the requisite transactions and/or items to a consolidation entity, such an individual in the group tasked with collecting and consolidating the data. Such a manual process is not only inefficient it is also highly inaccurate because it requires each individual in the group to identify and report transactions or items that are of interest to the group.

Therefore, a need exists to automatically identify transactions and/or items in transactions that are associated with a group of individuals, aggregate the data associated with such transactions and/or items and provide the individuals within the group access to the aggregated data associated with the group-related transactions and/or items.

### BRIEF SUMMARY

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention relate to systems, apparatus, methods, and computer program products for automatically identifying transactions and/or items in a transaction that are associated with a group of individuals, such as a family, co-workers, a special interest group, a demographic group a social network group or the like. Once transactions and/or items in the transaction have been identified as being associated with the group, the purchase data associated with the transactions and/or the items in the transactions is aggregated and aggregated views of the data are made accessible to individuals in the group, such as through a financial institution financial management application, e.g., online or mobile banking application.

The present invention relies on transaction item-identifying data, such as e-receipt data or the like that has been properly structured and formatted for financial institution accessibility. The structured transaction item-identifying data is used determine that the associated transaction and/or items in the transactions are linked to a group of individuals.

An apparatus for aggregating item-level transaction data for a group of individuals defines first embodiments of the invention. The apparatus includes a computing platform having a memory and at least one processor in communication with the memory device. The apparatus further includes an aggregation and structuring application that is stored in the memory and executable by the processor. The aggregation and structuring application is configured to receive transaction item-identifying data, associated with transactions including one or items, in an unstructured format, structure the transaction item-identifying data for financial institution compatibility and store the structured data in a first database.

The apparatus further includes a group determination application stored in the memory and executable by the processor. The group determination application is configured to access the transaction item-identifying data in the first database to determine that one or more of the transactions are associated with a group of individuals. Examples of the group of individuals include but are not limited to, a family, co-workers, a similar-demographic group, a similar-interest group, and a social media group. The apparatus further includes a group aggregation application that is stored in the memory, executable by the processor and configured to receive a plurality of item-identifying data associated with the one or more transactions, aggregate the plurality of item-identifying data and provide the individuals in the group access to the aggregated plurality of item-identifying data.

In specific embodiments of the apparatus the group determination application is further configured to (1) access a group database that associates financial payment accounts to groups of individuals and (2) determine that a financial payment account identifier in the transaction item-identifying data is matched to a financial payment account that is associated with a group of individuals.

In further specific embodiments of the apparatus, the group determination application is further configured to access the item-identifying data in the first database to determine that one or more items in the one or more transactions are associated with the group of individuals. In such embodiments of the apparatus, the group determination application may be further configured to (1) access an item database that associates at least one of (a) items and (b) types of items to groups of individuals (2) determine that an item identified in the transaction item-identifying data associated with a transaction is matched to one of (a) items or (b) types of items associated with the group of individuals. In further related embodiments of the apparatus, the group aggregation application may be further configured to configured to receive a plurality of item-identifying data associated with the items in the transactions, aggregate the plurality of item-identifying data and provide the individuals in the group access to the aggregated plurality of item-identifying data associated with the items in the transaction determined to associated with the group of individuals.

In still further alternate embodiments of the apparatus, the group aggregation application is included within a budgeting application that is configured to allow the group of individuals to manage budget for the group. In other related embodiments of the apparatus, the group aggregation application is included within an expense reporting and reimbursement application that is configured to provide for managing expense reporting and reimbursement for the group of individuals.

Moreover, in other specific embodiments of the apparatus, the group aggregation application is further configured to provide the individuals in the group pre-configured filtered access to the aggregated plurality of item-identifying data, such that the pre-configured filtered access provides for individuals in the group to access only item-identifying data that an individual in the group has been authorized to access.

In additional embodiments the apparatus may include a peer comparison application that is stored in the memory and executable by the processor. The peer comparison application is configured to determine peer data for at least one group of individuals similar to the group of individuals and provide the individuals in the group access to the peer data in comparison to the aggregated plurality of item-identifying data associated with the group of individuals.

In still further specific embodiments that apparatus includes a pattern recognition application that is stored in the memory and executable by the processor. The pattern recognition application is configured to determine, from the aggregated item-identifying data, one of transaction patterns or item patterns for the group of individuals, such that transaction patterns include a plurality of transactions with similar items and item patterns include similar items.

In other specific embodiments the apparatus includes a merchant share application that is stored in the memory and executable by the processor. The merchant share application is configured to communicate the aggregated plurality of item-identifying data to predetermined merchants. As a result, the predetermined merchants use the aggregated plurality of item-identifying data to determine items or services to offer to the group at a group discount.

A method for aggregating item-level transaction data for a group of individuals, defines second embodiments of the invention. The method includes receiving transaction item-identifying data, associated with transactions that include one or more items, in an unstructured format and structuring the transaction item-identifying data for financial institution system compatibility. The method further includes determining that more than one of the transactions are associated with a group of individuals and aggregating the plurality of item-identifying data associated with the transactions. Additionally the method includes generating an aggregated view of the aggregated plurality of item-identifying data that is accessible to at least one individual in the group of individuals.

In specific embodiments of the method, determining that the transactions are associated with a group of individuals further includes accessing a group database that associates financial payment accounts to groups of individuals and determining that a financial payment account identifier in the transaction item-identifying data is matched to a financial payment account that is associated with a group of individuals.

In alternate specific embodiments of the method, determining that the transactions are associated with a group of individuals further includes determining that one or more items in the one or more transactions are associated with the group of individuals. In such embodiments of the method, determining that the one or more items in the one or more transactions are associated with the group of individuals further includes accessing an item database that associates at least one of (a) items and (b) types of items to groups of individuals and determining that an item identified in the transaction item-identifying data associated with the one or more transactions is matched to one of (a) items or (b) types of items associated with the group of individuals. In related embodiments of the method aggregating may further include aggregating the plurality of item-identifying data associated with the one or more items and generating may further include generating the aggregated view of the aggregated plurality of item-identifying data associated with the items in the transaction determined to be associated with the group of individuals.

In still further specific embodiments of the method, generating the aggregated view further includes generating the aggregated view, such that the aggregated view is filtered for each individual in the group based on predetermined filtering criteria that defines item-identifying data accessible to a corresponding individual in the group.

Moreover, in other specific embodiments the method includes determining peer data for at least one group of individuals similar to the group of individuals and generating a peer view of the peer data that is presented in in comparison to the aggregated view. In still further embodiments the method includes determining, by a computing device processor, from the aggregated item-identifying data, one of transaction patterns or item patterns for the group of individuals, such that transaction patterns include a plurality of transactions with similar items and item patterns include similar items.

A computer program product that includes a non-transitory computer-readable medium defines third embodiments of the invention. The computer-readable medium includes a first set of codes for causing a computer to receive transaction item-identifying data, associated with a transaction that includes one or more items, in an unstructured format and a second set of codes for causing a computer to structure the transaction item-identifying data for financial institution system compatibility. The computer-readable medium additionally includes a third set of codes for causing a computer to determine that the transaction is associated with a group of individuals and a fourth set of codes for causing a computer to aggregate the structured item-identifying data associated with the transaction and other structured item-identifying data associated with other transactions determined to be associated with the group of individuals. In addition, the computer-readable medium includes a fifth set of codes for causing a computer to generate an aggregated view of the aggregated item-identifying data that is accessible to at least one individual in the group of individuals.

Thus, as described in more detail below, embodiments of the present invention relate to systems, apparatus, methods, and computer program products for automatically identifying transactions and/or items in a transaction that are associated with a group of individuals, such as a family, co-workers, a special interest group, a demographic group a social network group or the like. Once transactions and/or items in the transaction have been identified as being associated with the group, the purchase data associated with the transactions and/or the items in the transactions is aggregated and aggregated views of the data are made accessible to individuals in the group, such as through a financial institution financial management application, e.g., online or mobile banking application.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 is a schematic diagram representation of an operating environment for retrieval of electronic communications relating to customer purchase transactions, parsing of data within such electronic communications into structured data, formatting the data for financial institution accessibility and inclusion of such data into a network-accessible financial institution application, in accordance with embodiments of the present invention;

FIG. 2 is a block diagram of an apparatus for determining that transactions and/or items in the transactions are associated with a group of individuals and aggregating the data associated with the transactions and/or items for presentation to individuals in the group, in accordance with embodiments of the present invention;

FIGS. 3A and 3B are a more detailed block diagram of an apparatus for determining that transactions and/or items in the transactions are associated with a group of individuals and aggregating the data associated with the transactions and/or items for presentation to individuals in the group, in accordance with embodiments of the present invention;

FIG. 4 is a flow diagram of a method for determining that transactions and/or items in the transactions are associated with a group of individuals and aggregating the data associated with the transactions and/or items for presentation to individuals in the group, in accordance with embodiments of the present invention; and

FIG. 5 is a schematic diagram of an operating environment for determining that transactions and/or items in the transactions are associated with a group of individuals and aggregating the data associated with the transactions and/or items for presentation to individuals in the group, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

Various embodiments or features will be presented in terms of systems that may include a number of devices, components, modules, and the like. It is to be understood and appreciated that the various systems may include additional devices, components, modules, and the like and/or may not include all of the devices, components, modules and the like. discussed in connection with the figures. A combination of these approaches may also be used.

The steps and/or actions of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some embodiments, the processor and the storage medium may reside in an Application Specific Integrated Circuit (ASIC). In the alternative, the processor and the storage medium may reside as discrete components in a computing device. Additionally, in some embodiments, the events and/or actions of a method or algorithm may reside as one or any combination or set of codes and/or instructions on a machine-readable medium and/or computer-readable medium, which may be incorporated into a computer program product.

In one or more embodiments, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and high-definition DVD disc where disks usually reproduce data magnetically, while discs usually reproduce data optically with lasers. Combinations of the above should also be included within the scope of computer-readable media.

Thus, embodiments of the present invention provide for automatically identifying transactions and/or items in a transaction that are associated with a group of individuals, such as a family, co-workers, a special interest group, a demographic group a social network group or the like. Once transactions and/or items in the transaction have been identified as being associated with the group, the purchase data associated with the transactions and/or the items in the transactions is aggregated and aggregated views of the data are made accessible to individuals in the group, such as through a financial institution financial management application, e.g., online or mobile banking application.

The present invention relies on receipt of transaction item-identifying data, such as e-receipt data or the like to determine that a transaction and/or items in the transaction are associated with a group of individuals. Once the transaction has been identified as being associated with a group of individuals, the item-identifying data associated with the transaction is aggregated with other item-identifying from other transactions and/or items that have been identified as being associated with the group. The aggregated is data is then presented to individuals in the group, so that individuals in the group have knowledge as to what transactions and items or services are being purchased by members of the group.

In the past few years, there has been an increase in the amount of electronic information provided by merchants to customers regarding purchase of products and services. In the online purchase context, various electronic communications may be provided to the customer from the merchant relative to a purchase. For example, following an online purchase, the merchant may provide the customer an electronic order confirmation communication. The order confirmation may be sent to the customer's computer and displayed in a web browser application. The web browser application typically allows the customer to print a hard copy of the order confirmation and to save the confirmation electronically. The merchant will also typically send an email containing the order confirmation to the customer's designated email account. The order confirmation is otherwise referred to as an electronic receipt, commonly referred to as an e-receipt, for the online purchase. The order confirmation includes detailed information regarding the products or services purchased. For example, in the case of a product, the order confirmation may include stock keeping unit “SKU” code level data, as well as other parameters, such as an order number, an order date, a product description, a product name, a product quantity, a product price, a product image, a product image or a hyperlink to the product image on a merchant website, the sales tax incurred, the shipping cost incurred, an order total, a billing address, a third party shipping company, a shipping address, an estimated shipping date, an estimated delivery date, a shipment tracking number, and the like. The order confirmation also includes information about the merchant, such as the name of the merchant, the address of the merchant, a telephone number of the merchant, a web address, and the like. For most online transactions, the merchant will send at least one second communication confirming shipment of the order. The order shipment confirmation is typically also sent via email to the customer and typically includes the same information as the order confirmation, and in addition, a shipping date, a shipment tracking number, and other relevant information regarding the order and shipment parameters.

Many merchants now also provide the option for customers to receive e-receipts when shopping at “brick and mortar” locations (i.e., physical locations). In general, at the point of sale, the customer may have previously configured or may be asked at the time of sale as to whether he or she wishes to receive an e-receipt. By selecting this option, the merchant will send an electronic communication in the form of an e-receipt to the customer's designated email address. Here again, the e-receipt will typically include a list of services and/or products purchased with SKU level data, and other parameters, as well as information about the merchant, such as name, address, phone number, store number, web address, and the like.

Various merchants now also provide online customer accounts for repeat customers. These online customer accounts may include purchase history information associated with the customer, which are accessible by the customer via ID and passcode entry. Purchase history provides detailed information about services and products purchased by the customer including information found on order confirmations and shipping confirmations for each purchase. Online customer accounts are not limited to online purchases. Many merchants also provide online customer accounts for customers that purchase services and products at “brick and mortar” locations and then store these transactions in the customer's online account.

For the most part, order confirmations, shipping confirmations, e-receipts, and other electronic communications between merchants and customers are used only by the customer as proof-of-purchase and for monitoring receipt of purchased items (i.e., for archival purposes). However, there is significant data that can be gleaned from this electronic information for the benefit of the customer, so that the customer may have detailed information regarding purchase history, spending, and the like.

Another development in the past few years has been the growth of online banking, mobile banking and the like, whereby financial institution customers, (such as bank and credit card customers), may view financial account transaction data, perform online payments and money transfers, view account balances, and the like. Many current online banking applications are fairly robust and provide customers with budgeting tools, financial calculators, and the like to assist the customer to not only perform and view financial transaction date, but also to manage finances. A current drawback with online banking is that transactional level detail for a given purchase by the customer is limited. Despite the large amount of information sent by merchants to customers regarding purchases, merchants currently do not provide purchase details to financial institutions. The only information provided by the merchant to the financial institution is information about the merchant and an overall transaction amount. For example, if a financial institution customer purchases several clothing items from a merchant and uses a financial institution debit card, credit card or a check, all that is provided to the financial institution is the merchant information and overall purchase amount. Product level detail that is present on the receipt provided to the customer by the merchant is not provided to the financial institution.

The lack of detailed information regarding a given transaction in the online banking environment limits a customer's ability to ascertain a larger picture of purchase history and financial transaction information. As a first example, if a customer makes several purchases within a short time period with a particular merchant, all that the customer will see in online banking for each purchase is an overall dollar amount, the merchant name, and date of the purchase transaction. If the customer cannot recall, what a particular purchase was for or whether it was a legitimate transaction, the customer cannot view details regarding the purchase via online banking to aid in the inquiry. Instead, the customer must locate and review receipts from the purchases and match them by date and/or total purchase amount to online banking data to perform such analysis.

Lack of detailed purchase information also hinders use of other financial tools available to the customer in online banking, such as budgetary tools. In general, budgetary tools divide expenses into various categories, such as food, clothing, housing, transportation, and the like. It is typically advantageous to provide such budget tools with online banking information to populate these various categories with spend information. However, this is difficult where specifics regarding a purchase made by the merchant (such as SKU level data) are not provided by the merchant to the financial institution for a given financial transaction. As many stores provide a wide variety of services and products, such as in the case of a “big box” store that provides groceries, clothing, house hold goods, automotive products, and even fuel, it is not possible to dissect a particular purchase transaction by a customer at the merchant for budget category purposes. For this reason, many current online budgeting tools may categorize purchases for budgeting by merchant type, such as gas station purchases are categorized under transportation and grocery store purchases are categorized under food, despite that in reality, the purchase at the gas station may have been for food or the purchase at the grocery store could have been for fuel. Alternatively, some budget tools may allow a customer to parse the total amount of a purchase transaction between budget categories by manually allocating amounts from the purchase transaction between each budget category. This requires added work by the customer and may be inaccurate, if the customer is not using the receipt in making such allocations or the customer fails to recall exactly what items were purchased in previous transactions.

Traditional cash purchases are also problematic for integration of customer purchase transactions into online banking In a cash transaction, the customer may initially withdraw cash from a financial account and then use the money for a purchase. In this instance, the customer's online banking will have no information whatsoever regarding the purchase transaction with a merchant, as there is no communication regarding the purchase transaction between the financial institution and the merchant. For example, if the customer uses cash to purchase fuel at a gas station, the financial institution has no way of determining that the purchase transaction occurred and cannot use such information for notifying the customer of spending or budgeting regarding the fuel purchase.

As described above, currently financial institutions are not provided with detailed transaction level information regarding a purchase transaction by a customer from a merchant beyond merchant information and overall transaction price for inclusion in online banking While detailed data (such as SKU level data) is provided to the customer via receipts, such information is not provided by the merchant to the financial institution. The information is available to the customer but not integratable into a customer's online banking for efficient and increased beneficial use of the information. Currently, a customer must retain her receipts and manually compare such receipts with online purchase transaction data and manually input related data into online banking to obtain an understanding of the details of a given purchase transaction.

In light of the above, the current invention contemplates use of purchase confirmation or e-receipt data and other electronic communication data between a merchant and customer regarding a transaction (referred to herein as transaction item-identifying data) in order to augment purchase transaction data in online banking, mobile banking and the like. The general concept is to retrieve such electronic communications from the customer, parse the data in these electronic communications, and associate the data from the electronic communications with the corresponding online purchase transaction data.

An initial barrier to integration of electronic communication data received by a customer from a merchant regarding a purchase transaction for inclusion into online banking is data format. Online banking data is in a structured form. Financial institutions currently use a data structure conforming to Open Financial Exchange “OFX” specifications for the electronic exchange of financial data between financial institutions, businesses and customers via the Internet. E-receipts, such as electronic order confirmations, shipment confirmation, receipts, and the like typically do not comply to a uniform structure and are generally considered to include data in an “unstructured” format. For example, while one merchant may provide data in an electronic communication to a customer in one format, another merchant may use a completely different format. One merchant may include merchant data at the top of a receipt and another merchant may include such data at the bottom of a receipt. One merchant may list the purchase price for an item on the same line as the description of the item and list the SKU number on the next line, while another merchant may list the data in a completely opposite order. As such, prior to integration of electronic communications relating to customer purchases into online banking, the data from such electronic communications must be parsed into a structured form.

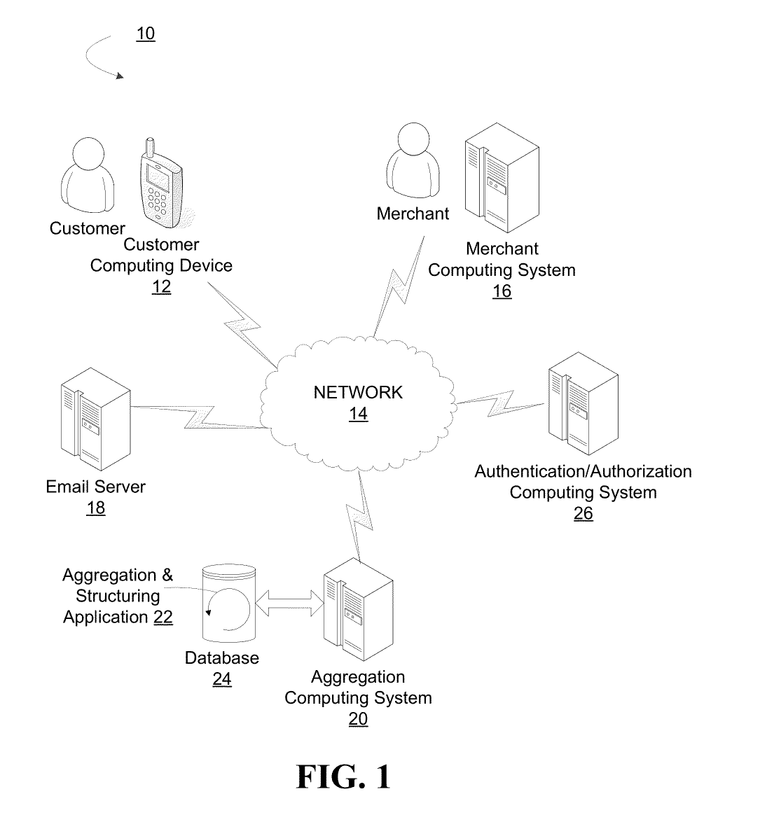

FIG. 1 is a diagram of an operating environment 10 according to one embodiment of the present invention for retrieval of electronic communications relating to customer purchase transactions, parsing of data within such electronic communications into structured data, formatting the data for financial institution accessibility and inclusion of such data into a network-accessible banking application, such as online or mobile banking. As illustrated a consumer maintains one or more computing devices 12, such as a PC, laptop, mobile phone, tablet, television, or the like that is network accessible for communicating across a network 14, such as the Internet, wide area network, local area network, short range/near field network, or any other form of contact or contactless network. Also, in the operating environment, are one or more merchant computing systems 16 that is network accessible. In the context of an online shopping experience, the merchant computing system 16 may be one or more financial transaction servers that, either individually or working in concert, are capable of providing web pages to a customer via the network 14, receiving purchase orders for items selected by the customer, communicating with the customer and third party financial institutions to secure payment for the order, and transmitting order confirmation, and possibly shipping confirmation information, to the customer via the network 14 regarding the purchase transaction. In the context of an in-store purchase, the merchant computing system 16 may include a point of sale terminal for scanning or receiving information about products or services being purchased by the customer and communicating with the customer and third party financial institutions to secure payment for the order. Either the point of sale device or a connected merchant server may be used to communicate order confirmation or purchase confirmation information (e.g., e-receipt) to the customer related to the purchase transaction. If the customer has an online account with the merchant, the merchant computing system may also log the transaction information into the customer's online account.

In general, the merchant computing system will provide the customer with information relating to the purchase transaction. In the context of an online purchase, the communications may take the form of purchase order confirmations provided as a web page or as an email or as both. In some, embodiments, the merchant computing system may provide a web page purchase order confirmation, and advise the customer to either print, electronically save, or book mark the confirmation web page. The purchase order confirmation is essentially an e-receipt for the online purchase transaction. The order confirmation includes detailed information regarding the products or services purchased, such as for example, in the case of a product, SKU code level data, as well as other parameters associated with the product, such as type/category, size, color, and the like, as well purchase price information, information associated with the merchant, and the like. The merchant computing system may also send other subsequent communications, such as communications confirming shipment of the order, which typically includes the same information as the purchase order confirmation, and in addition, shipping date, tracking number, and other relevant information regarding the order. In the context of an in-store purchase, the merchant computing system may send an e-receipt comprising information similar to that of the purchase order confirmation. In some instances, the customer may actually receive a paper receipt, which the customer may choose to scan into an electronic form and save in a storage device associated with the customer computing device 12. In the description herein, the term e-receipt may be used generically to refer to any communication or document provided by a merchant to a customer relating to a purchase transaction.

For a plurality of different purchase transactions, a customer may include purchase transaction item-identifying data (e.g., order confirmations, shipping confirmations, e-receipts, scanned receipts, typed or handwritten notes, invoices, bills of sale, and the like) in various locations and in various forms. The transaction item-identifying data could be stored in a storage device associated with the customer computing device 12, or in an email server 18, or in a customer's account at the merchant's computing system 16. Furthermore, as mentioned, the transaction item-identifying data is in an unstructured format. Each merchant may use a customized reporting format for the communications, whereby various data relating to the purchase transaction may be placed in different sequences, different locations, different formats, and the like for a given merchant. Indeed, a given merchant may even use different data formatting and structuring for different communications with the customer (e.g., order confirmation, shipping, confirmation, e-receipt, online customer account information, and the like).

To aggregate and structure data related to purchase transactions, the operating environment further comprises an aggregation computing system 20 including aggregation and structuring application 22 stored in database 24. The aggregation computing system 20 is operatively connected to at least one of the customer computing device 12, the merchant computing system 16, and the email server 18 via the network 14. The aggregation and structuring application 22 is configured to initially crawl (i.e., search and locate) electronic communications associated with purchase transactions made by the customer, in for example, the customer's email, computer storage device, online accounts, and the like. For this purpose, the system may optionally include an authentication/authorization computing system 26 that comprises security IDs and passwords and other security information associated with the customer for accessing customer's email, storage devices, and customer online accounts.

Regarding email extraction, aggregation and structuring application 22 initially gains access to the customer's email accounts and retrieves email message headers comprising data fields relative to the email message, such as sender, subject, date/time sent, recipient, and the like. In some embodiments, the aggregation computing system accesses the emails directly. In other embodiments, the aggregation computing system may run search queries of the email database based on known merchant names and/or phrases associated with e-receipt information, such as “receipt,” “order confirmation,” “shipping confirmation,” or the like. Once emails are extracted, further filtering may occur to locate relevant emails. Examples of further filtering may be searches based on known online merchants, third parties known to provide e-receipts, text in the email message subject line that corresponds to known order confirmation subject line text or known shipping confirmation subject line text, such as an email message sent with a subject line containing the text “purchase,” “order,” “ordered,” “shipment,” “shipping,” “shipped,” “invoice,” “confirmed,” “confirmation,” “notification,” “receipt,” “e-receipt,” “return,” “pre-order,” “pre-ordered,” “tracking,” “on its way,” “received,” “fulfilled,” “package,” and the like.

Based on the email header analysis, the message bodies for emails of interest may then be accessed. The retrieved email message bodies for the identified email messages of interest are parsed to extract the purchase transaction information and/or shipping information contained therein. Such parsing operation can occur in a variety of known ways. However, because the text included in email message bodies is unstructured (as opposed to the structured tagged elements in a hypertext markup language (HTML) web page, which delineate and make recognizable the various fields or elements of the web page), in one embodiment predefined templates are used that have been specifically created to identify the various individual elements or entities of interest in a given email from an online merchant. Use of these predefined templates to parse a retrieved email message body occurs within aggregation and structuring application 22. Because it is known from header information which merchant sent the email message of interest and whether the email message is a purchase order confirmation or a shipping confirmation from either the header or the message body information, a template specific to the merchant and type of confirmation may be used. Still further, because email message bodies can, as is known in the art, be in either a text or HTML format, a template specific to the type of email message body format may be used in some embodiments.

As an example, for each merchant there are typically four different parsing templates which can be used for electronic communications relating to purchase transactions: i) a text order confirmation template; ii) an HTML order confirmation template; iii) a text shipping confirmation template; and iv) an HTML shipping confirmation template. In instances in which the email is an e-receipt from a “brick and mortar” purchase, another template may be used that is specific to the merchant. For some online merchants there are greater or fewer templates depending upon what are the various forms of email messages a given online merchant typically sends. Regardless of the number of templates for a given merchant, each template is specific as to the known particular entities typically included and the order they typically occur within each type of email confirmation message sent by that merchant.

The above describes parsing of email purchase order confirmation, shipping confirmation, or e-receipt data. As mentioned, a customer may scan and save paper receipts, typed or printed notes, invoices, bills of sale, and the like in a storage device or print and save purchase order and shipping confirmation communications sent to the customer by the merchant via a web page. In this instance, the aggregation and structuring application 22 may first perform optical character recognition “OCR” on the scanned or printed receipts prior to perform the processing performed above. Further, a customer may maintain an online account with a merchant containing purchase data information. In this instance, the aggregation computing system 20 will access the data online via communication with merchant computing system to retrieve this data. The aggregation computing system 20 may use column and/or row headers associated with the online data to parse the data, or it may use procedures similar to the above and discussed below to parse the data into appropriate fields.

Returning to data processing procedures, in some embodiments, context-free grammars “CFGs” are used to parse fields from purchase transaction data. In some embodiments, instead of using grammars for parsing natural language (e.g., English) structures, the system may use defined smaller grammars describing a particular message format, for example: “(Greetings from merchant) (Details about order) (Details about item 1) (Details about item 2) . . . (Details about item N) (Tax and totals calculation),” and the like. Further, the CFGs may be individually defined, such as in a Backus-Naur Form (BNF) format, or templates may be used for data extraction. In instances, where templates are used, these created templates are grammar and can be converted by known tools, such as Another Tool for Language Recognition “ANTLR”, into mail-specific grammars or e-receipt-specific grammars or online customer account information-specific grammars. ANTLR is then used again to convert these grammars into extraction parsers, which can be used by the aggregation computing system 20 to parse the email message bodies, e-receipt bodies, online data, and the like to extract the entities of interest from them. Examples of such extracted entities include merchant name, merchant web address, order number, order date, product description, product name, product quantity, product price, product image, hyperlink to the product image on merchant website, sales tax, shipping cost, order total, billing address, shipping company, shipping address, estimated shipping date, estimated delivery date, tracking number, and the like.

Once the data has been properly parsed, the data may be required to be formatted to conform to financial institution specifications. For example, as previously noted, the data may be formatted to conform to Open Financial Exchange “OFX” specifications for the electronic exchange of financial data between financial institutions, businesses and customers via the Internet.

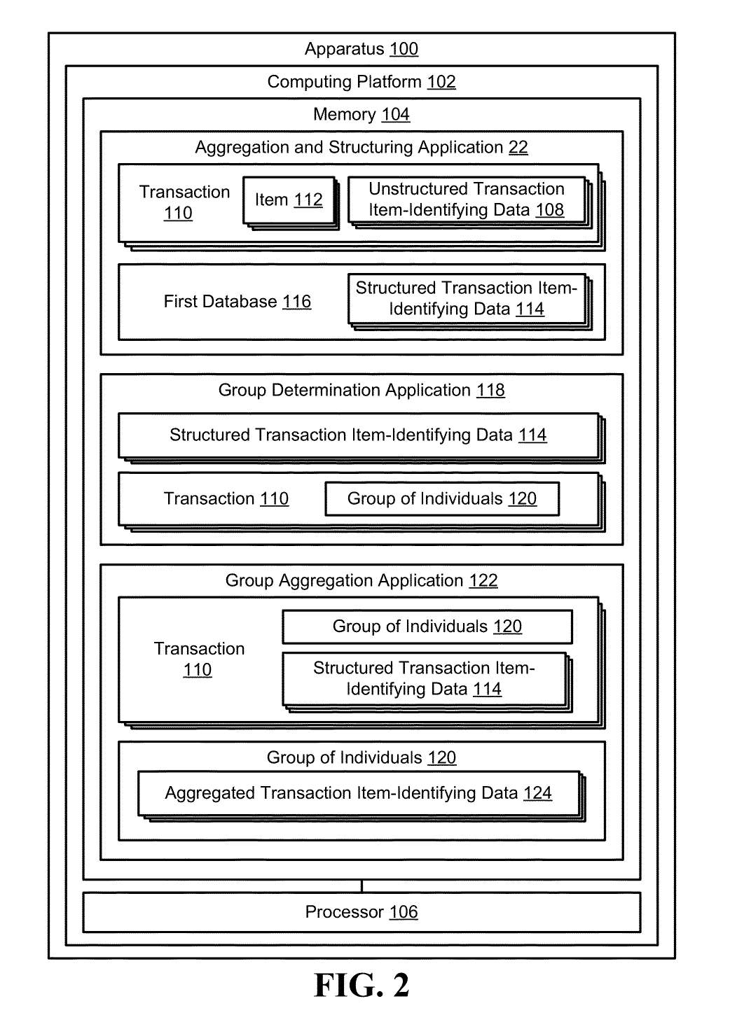

FIG. 2 provides a block diagram of an apparatus 100 configured for determining that transactions are associated with a group of individuals and aggregating the data associated with the transactions for presentation to individuals in the group, in accordance with embodiments of the present invention. The apparatus includes a computing platform 102 having a memory 104 and at least one processor 106 that is communication with the memory 104. The memory 104 of apparatus 100 stores aggregation and structuring application 22 that is executable by processor 106 and configured to receive unstructured transaction identifying-data 108, such as an e-receipt, including a purchase confirmation, a shipping confirmation; a scanned receipt and the like, associated with a transaction 110 that includes items 112 (“items” as used herein may include tangible goods and services), process the data to result in structured transaction item-identifying data 114 and store the structured transaction item-identifying data 114 in an associated database (first database) 116. The processing of such data is described in detail in relation to FIG. 1 and may include crawling email accounts to collect e-receipts and the like from a customer's email account, parsing the transaction item-identifying data using predetermined templates to render item-identifying data and other relevant data from the e-receipts and the like, and formatting the data in a format accessible to financial institution systems, such as personal finance management systems (e.g., online banking, mobile banking and the like).

Memory 104 of apparatus 100 additionally includes group determination application 118 that is executable by processor 106 and is configured to access the structured transaction item-identifying data 114 in the first database 116 to determine that transactions 110 are associated with a group of individuals 120. In this regard, “associated with a group of individuals” means that the transaction has been conducted by an individual in the group or conducted by an individual not in the group but on behalf of the group of individuals. The group of individuals may be any group of individuals that benefit from knowledge of what other individuals in the group have purchased. Such groups may include but are not limited to a family (extending outside a household), co-workers, similar-demographic group, similar-interest group, social network group or the like.

Memory 104 of apparatus 100 additionally includes group aggregation application 122 that is executable by the processor 106 and configured to receive (or access) the structured item-identifying data 114 associated with the transactions 110 that have been determined to be associated with the group of individuals 120. The group aggregation application 122 is further configured to aggregate the structured item-identifying data 114 and provide one or more individuals in the group of individuals 120 access to the aggregated transaction item-identifying data 124. For example, a network-based financial institution application, such as online banking or mobile banking may present individuals in the group access to the aggregated transaction item-identifying data, such as a listing of the transactions conducted by individuals in the group or on behalf of the group, which may include, but is not limited to, the items in the transaction, the date of the transaction, the transaction amount, the item(s) amount, the merchant at which the transaction occurred and the like.

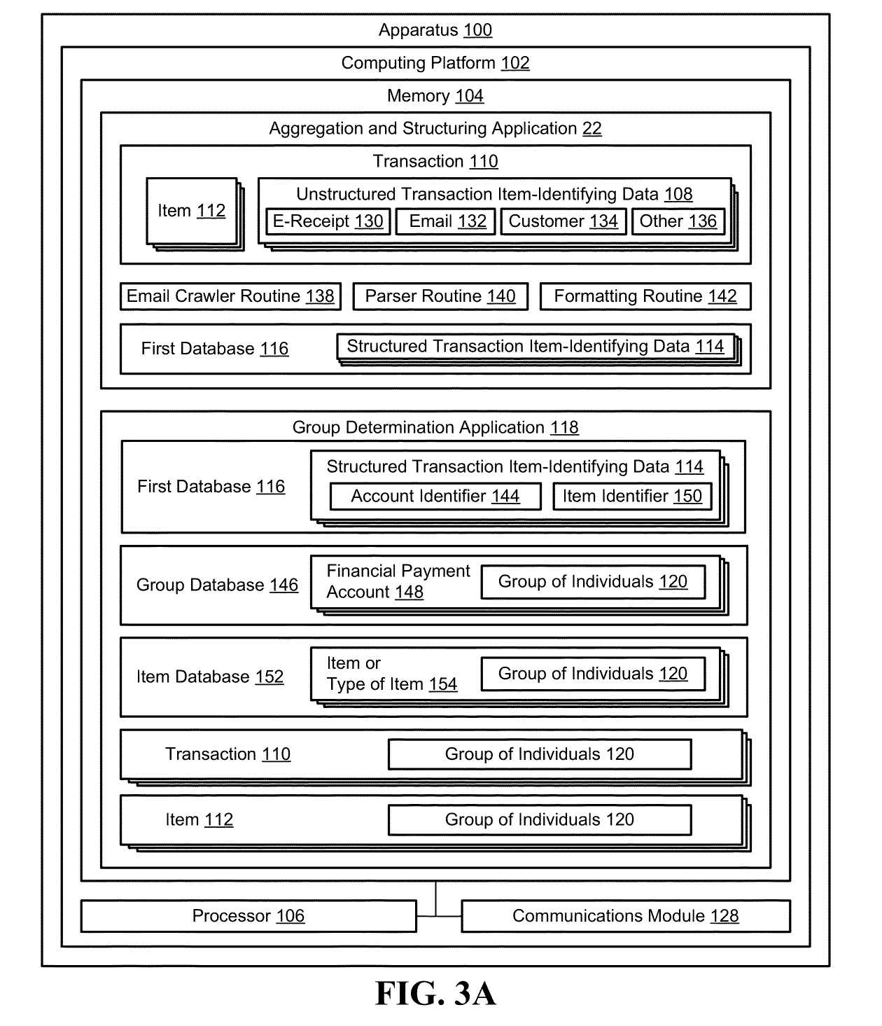

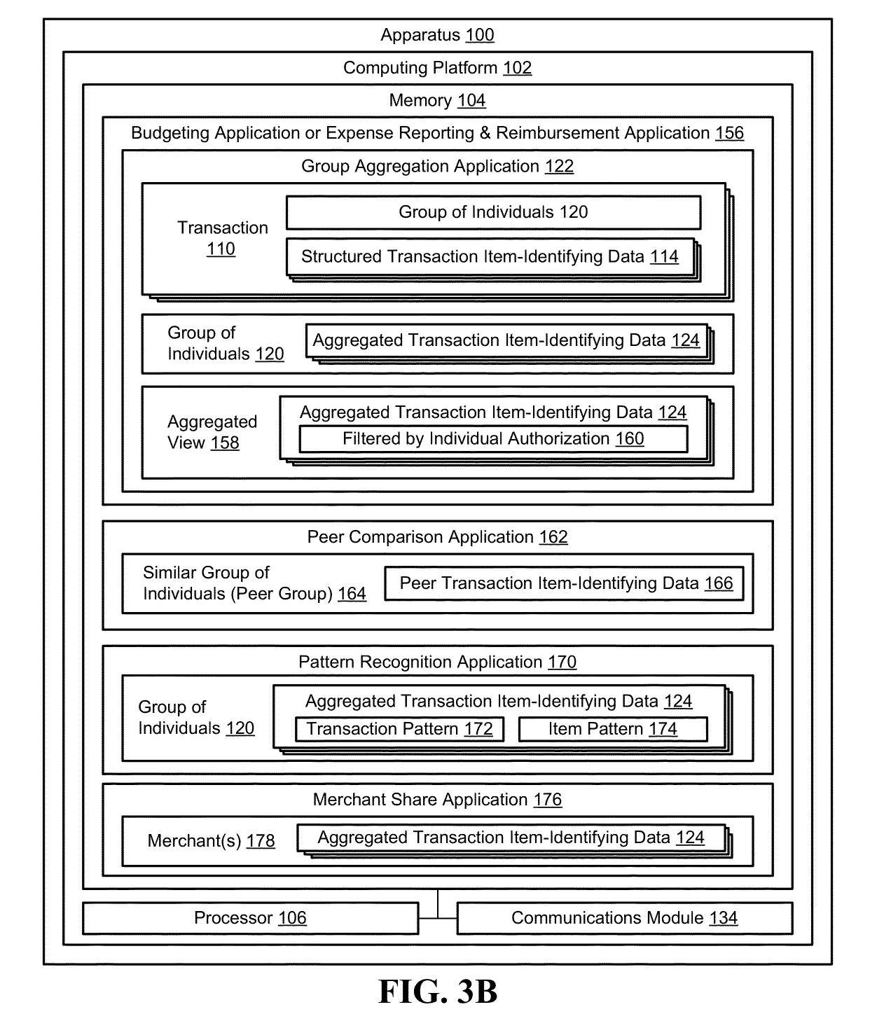

Referring to FIGS. 3A and 3B shown is a more detailed block diagram of apparatus 100, according to embodiments of the present invention. As previously described, the apparatus 100 is configured to determining that transactions are associated with a group of individuals and aggregating the data associated with the transactions for presentation to individuals in the group. In addition to providing greater detail, FIGS. 3A and 3B highlight various alternate embodiments of the invention. The apparatus 100 may include one or more of any type of computerized device. The present apparatus and methods can accordingly be performed on any form or combination of computing devices, including servers, personal computing devices, laptop/portable computing devices, mobile computing devices or the like.

The apparatus 100 includes computing platform 102 that can receive and execute routines and applications. Computing platform 102 includes memory 104, which may comprise volatile and non-volatile memory, such as read-only and/or random-access memory (RAM and ROM), EPROM, EEPROM, flash cards, or any memory common to computer platforms. Further, memory 104 may include one or more flash memory cells, or may be any secondary or tertiary storage device, such as magnetic media, optical media, tape, or soft or hard disk.

Further, computing platform 102 also includes processor 106, which may be an application-specific integrated circuit (“ASIC”), or other chipset, processor, logic circuit, or other data processing device. Processor 106 or other processor such as ASIC may execute an application programming interface (“API”) (not shown in FIGS. 3A and 3B) that interfaces with any resident programs, such as aggregation and structuring application 22, group determination application 118, group aggregation application 122, peer comparison application 162, patter recognition application 170 and merchant share application 176 or the like stored in the memory 104 of the apparatus 100.

Processor 106 may include various processing subsystems (not shown in FIGS. 3A and 3B) embodied in hardware, firmware, software, and combinations thereof, that enable the functionality of apparatus 100 and the operability of the apparatus on a network. For example, processing subsystems allow for initiating and maintaining communications and exchanging data with other networked devices. For the disclosed aspects, processing subsystems of processor 106 may include any subsystem used in conjunction with aggregation and structuring application 22, group determination application 118, group aggregation application 122, peer comparison application 162, patter recognition application 170 and merchant share application 176 or subcomponents or sub-modules thereof

Computer platform 102 additionally includes communications module 134 embodied in hardware, firmware, software, and combinations thereof, that enables communications among the various components of the apparatus 100, as well as between the other devices in the transaction system, the aggregation and structuring system and/or the financial institution system. Thus, communication module 134 may include the requisite hardware, firmware, software and/or combinations thereof for establishing a network communication connection and initiating communication amongst networked devices.

As previously noted and shown in FIG. 3A, the memory 104 of computing platform 102 stores aggregation and structuring application 22 that is executable by processor 106 and configured to receive unstructured transaction identifying-data 108, such as e-receipts 130, (e.g., purchase confirmations, shipping confirmations), other relevant emails 132, customer inputted data 134 (e.g., scanned hard-copy receipts or manually inputted hard copy receipt data) and any other data indicating a transaction conducted by the customer and the items included in the transaction 136, and process the data to result in structured transaction item-identifying data 114. In specific embodiments of the invention, the aggregation and structuring application 22 includes email crawler routine 138 that is configured to crawl email accounts(s) of the customer to identify and collect emails that include transaction data. Details of the email crawler routine 144 are discussed in relation to FIG. 1. The emails may include e-receipts, which collectively include, purchase confirmations, shipping confirmations, and any other emails indicating a transaction and/or the items included in the transaction.

The aggregation and structuring application 22 may additionally include parser routine 140 that is configured to implement predetermined templates to parse relevant data from the unstructured transaction item-identifying data 108. As discussed in detail in relation to FIG. 1, the predetermined templates may be configured to parse data such as, but not limited to, merchant name, merchant contact information, transaction location (i.e., physical location or online), item identifiers, such as SKUs, UPCs or the like, item names, item amount, total purchase amount, tax amount, data and time or transaction, shipping information and the like.

The aggregation and structuring application 22 may additionally include formatting routine 142 that is configured to format the parsed data into a format that is compatible and/or accessible to financial institutions. For example, in specific embodiments, the parsed data may be formatted to conform to Open Financial Exchange “OFX” specifications for the electronic exchange of financial data between financial institutions, businesses and customers via the Internet. Once parsed and formatted, the structured transaction item-identifying data 114 may be stored in a requisite database 116 for subsequent access by the financial institution or other entities authorized by the customer to have access to such transaction item-identifying data.

As previously discussed in relation to FIG. 2, the memory 104 of apparatus 100 additionally includes group determination application 118 that is executable by processor 106 and is configured to access the structured transaction item-identifying data 114 in the first database 116 to determine that transactions 110 are associated with a group of individuals 120. In this regard the structured transaction item-identifying 114 includes an account identifier 144 (e.g., the last four digits of credit/debit card number or the like). Since the structured transaction item-identifying 114 is linked to a specific customer, the account identifier 114 and the identity of the customer can be used to determine the financial payment account 148 used to conduct the transaction. In specific embodiments of the invention, the group determination application 118 is configured to access a group database 146 that associates (e.g., stores a matching table or the like) financial payment accounts 148 with groups of individuals 120 and determine that the payment account used to conduct a transaction is associated with one or more groups of individuals. In this regard, individuals in the group, such as family members or the like, may register payment accounts as being payment accounts associated with the group or individuals in the group, such as co-workers or the like, may be issued payment accounts that are linked to the group.

In further embodiments of the invention, the group determination application 118 is configured to determine that specific item(s) 112 in the transactions are associated with the group 120. As previously noted the transaction item-identifying data includes item identifying data such as Stock Keeping Unit (SKU) or the like. In such embodiments of the invention, the group determination application 118 is configured to access an item database 152 that associates (e.g., stores a matching table or the like) specific items or types of items 154 with groups of individuals 120 and determine that one or more items in a transaction associated with the group are items associated with the group. In this regard, individuals in the group or some other designated individual may define what items or types of items are relevant to the group. For example, if the group is a special interest group, such as group of individuals interested in fishing, the items or types of items may be limited to fishing items, accessories and the like.

Referring to FIG. 3B, the memory 104 of apparatus 100 additionally includes group aggregation application 122 that is executable by the processor 106. In specific embodiments of the invention, the group aggregation application may be configured to be included in a budgeting application or an expense reporting and reimbursement application 156. The group aggregation application 122 is configured to receive (or access) the structured item-identifying data 114 associated with the transactions 110 that have been determined to be associated with the group of individuals 120. The group aggregation application 122 is further configured to aggregate the structured item-identifying data 114 and provide one or more individuals in the group of individuals 120 access to the aggregated transaction item-identifying data 124. In specific embodiments, access to the aggregated transaction item-identifying data 124 is provided by one or more aggregated views 158, which may include a listing of the transaction as well as item-level details related to the transaction, such as items in the transaction, item amount, total transaction amount, date of transaction, merchant and the like. In specific embodiments of the invention, the aggregated views 158 may be configured to provide for pre-configured filtered access 160 to the aggregated transaction item-identifying data 124 based on individual authorization. The filtered access 160 may limit which individuals in the group have access to view which particular transactions. For example, certain individuals in the group may be configured to view all of the transactions from of individuals in the group, while other individuals may be configured to view only those transactions from a designated portion of the individuals in the group. In addition, filtered access may limit which items in the transaction that individuals in the group have access to view. For example, certain individuals in the group may be configured to view all of the items in the transactions from of individuals in the group, while other individuals may be configured to view only those items designated as relevant to the group

In those embodiments of the invention in which the group determination application 118 is configured to determine items 112 in the transaction 110 that are associated with the group of individuals 120, the aggregated view 158 may be limited to providing a listing of only those items in the transaction that have been determined to be associated with the group. In other words, items in the transaction that are not associated with the group are not included in the aggregated views 158.

In optional embodiments the memory 104 of apparatus 100 may include peer comparison application 162 that is executable by the processor 106 and configured to compile (e.g., aggregate) peer transaction item-identifying data 166 for at least one group of individuals that are similar (i.e., a peer group) 164 to another group of individuals. In this regard the peer data 166 may presented to individuals in a group 120 for comparison to their own aggregated transaction item-identifying data 114. The peer group may be similar in terms of the number of individuals in the group and/or similar demographics, interests or similar in other group-defining attributes. Comparison data may be instrumental in highlighting areas that the group can improve upon for subsequent budgeting.

In further optional embodiments the memory 104 of apparatus 106 includes pattern recognition application 170 that is executable by the processor 106 and configured to identify transaction patterns 172 and/or item patterns 174 in the aggregated transaction item-identifying data 124. Transaction patterns include a plurality of similar or same transactions (i.e., transactions with similar or same items) and item patterns include similar items. Transaction patterns and/or items patterns 174 can be used to readily identify items that are being purchased by a series of individuals in the group. As such, the item pattern may indicate items that other individuals in the group may consider for purchase in the near term. For example, if the group of individuals are members of the same neighborhood with the houses all built proximate in time to one another and an item pattern has been identified for air conditioning units, other individuals in the group may consider replacing their air conditioning unit prior to the unit failing or prior to the warm weather season. In additional embodiments, the transaction patterns and/or item patterns may be used by a fraud detection application (not shown in FIG. 3B) to assist in detecting fraudulent transactions.

In still further embodiments the memory 104 of apparatus 106 includes merchant share application 176 that is configured to communicate at least a portion of the aggregated transaction item-identifying data 124 to designated merchants 178. In turn, the designated merchants use the aggregated data 124 to determine items or services to offer to the group and, in some embodiments to offer to the group at a discount. In certain embodiments, the aggregated transaction item-identifying data 124 that is communicated to the merchants 178 is transaction patterns 172 and/or item patterns 174. In this regard, the merchant is made aware of what items have recently been purchased by more than one individual in the group and, as such, the merchant may able to ascertain what other items will need in the future or provide a discount for future purchases of the item by the group, since the group has shown a willingness to purchase such items. In other embodiments of the invention, the data that is communicated to a designated merchant is limited to data that is relevant to that merchant, i.e., date related to items or services that can be provided by the merchant.

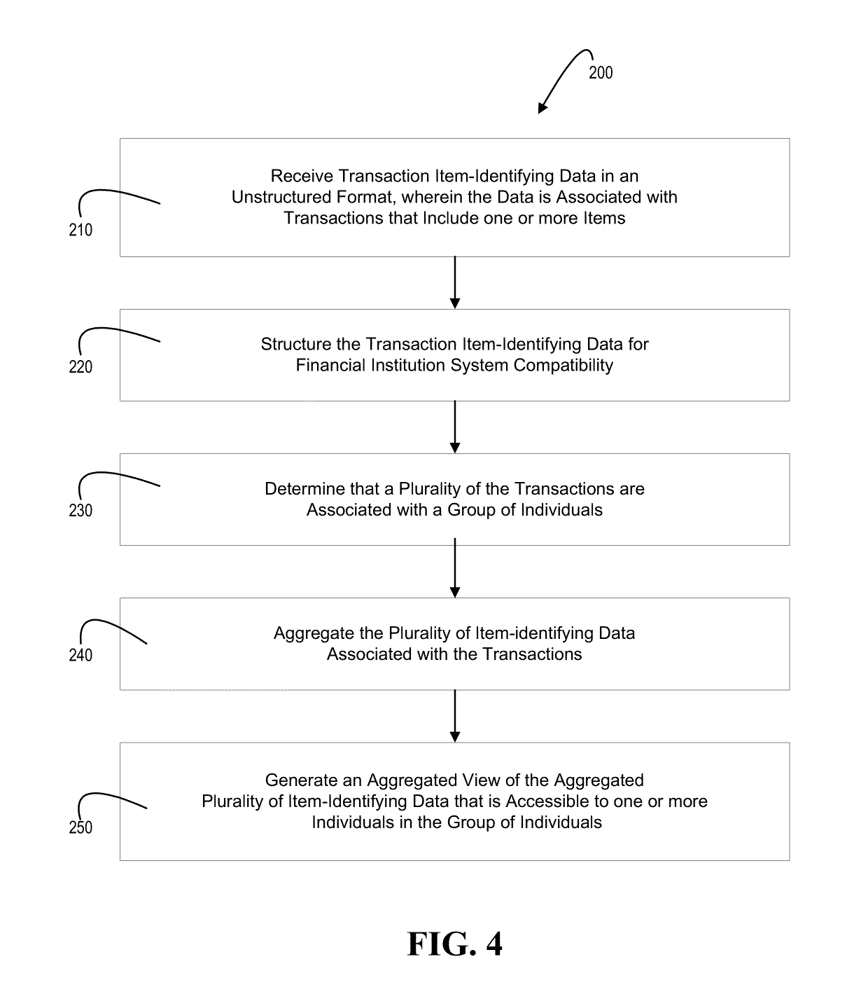

Referring to FIG. 4, a flow diagram of a method 200 for determining that transactions are associated with a group of individuals and aggregating the data associated with the transactions for presentation to individuals in the group, in accordance with embodiments of the present invention. At Event 210, transaction item-identifying data is received in an unstructured format. The transaction item-identifying data is associated with transactions including one or more items and may include e-receipts (e.g., purchase confirmation emails, shipping confirmation emails or the like), data from receipts scanned by the customer/user or manually inputted by the user/customer or data otherwise received or harvested from a merchant or customer. In specific embodiments of the invention, the transaction item-identifying data is received by crawling one or more email accounts associated with the customer to identify emails received that include the transaction item-identifying data (i.e., purchase confirmation emails, shipping confirmation emails or the like).

At Event 220, the unstructured transaction item-identifying data is structured for financial institution system capability. Structuring of the data may include applying a predetermined template to the data to parse or otherwise identify data that has been identified as relevant. The template(s) that is/are chosen to be applied to the data may be based on the form of the transaction item-identifying data, i.e., certain templates may apply to e-receipts, other templates may apply to customer inputted or scanned data. In addition to parsing data from the unstructured transaction item-identifying data, structuring the data may include reformatting the data to a format compatible with financial institution processing. For example, in specific embodiments, the data may be reformatted to conform to Open Financial Exchange “OFX” specifications for the electronic exchange of financial data between financial institutions, businesses and customers via the Internet. Once parsed and reformatted the structured data may be stored in an associated database.

At Event 230, transactions are determined to be associated with a group of individuals. The group of individuals may be any predetermined grouping of individuals that, in some embodiments, has been formed for the purpose of having knowledge as to what other individuals purchase and specifically what other individuals purchase as it pertains to the group. Examples of groups include, but are not limited to, families existing in multiple households, co-workers in a small business, special-interest/hobby group, similar demographic group, social network group and the like. In specific embodiments transactions are determined to be associated with the group by (1) determining the payment account used to conduct the transaction based on knowledge of the customer associated with the item-identifying data and an account identifier (e.g., last four digits of account) included in the transaction item-identifying data and (2) once the payment account is determined, accessing a group database that matches payment accounts to groups of individuals to determine the group of individuals associated with the transactions.

In other specific embodiments of the method, specific items in the transaction are determined to be associated with the group. In such embodiments the items are determined to be associated with the group by accessing an item database that matches items and/or types of items to groups and comparing the item-identifying data (e.g., SKU, UPC or the like) to the items and/or item types listed for the determined group.

At Event 240, the plurality of structured transaction item-identifying data associated with a group is received and aggregated. In specific embodiments of the method such aggregation will be at the transaction-level, meaning aggregation will include all of the items in all of the transactions that have been determined to be associated with the group. In other embodiments of the method, aggregation will be at the item-level, meaning aggregation will include only those items in the transactions that have been determined to be associated with the group. The transaction item-identifying data that is aggregated may include any data included in the structured data including, but not limited to, items in the transaction, item price, total transaction amount, date of purchase, merchant, the customer/transactor and the like.

At Event 250, one or more aggregated views of the aggregated transaction item-identifying data are generated and made accessible to at least one individual in the group. The aggregated views include a listing of transactions and/or the items included in the transactions that are associated with the group. In specific embodiments the aggregated views are made accessible to all of the individuals in the group. In other specific embodiments of the method, the aggregated views may be filtered based on pre-determined authorization granted to individuals in the group. For example, certain individuals may only be authorized to view transaction data from a portion of the overall group or only authorized to view specific items or item types, in which case filtered views will be generated and presented to these individuals. While in other instances, certain individuals in the group may be authorized to view transaction data from all individuals in the group and/or authorized to view all items in the aggregated data and, as such no filtered aggregated views will be generated and presented to these individuals. In additional embodiments, certain individuals may be authorized to view who the customer/transactor was in a transaction, while in other instances individuals may not be authorized to view who the transactor/customer was or only authorized to view who the transactor/customer was for a designated portion of the individuals in the group.

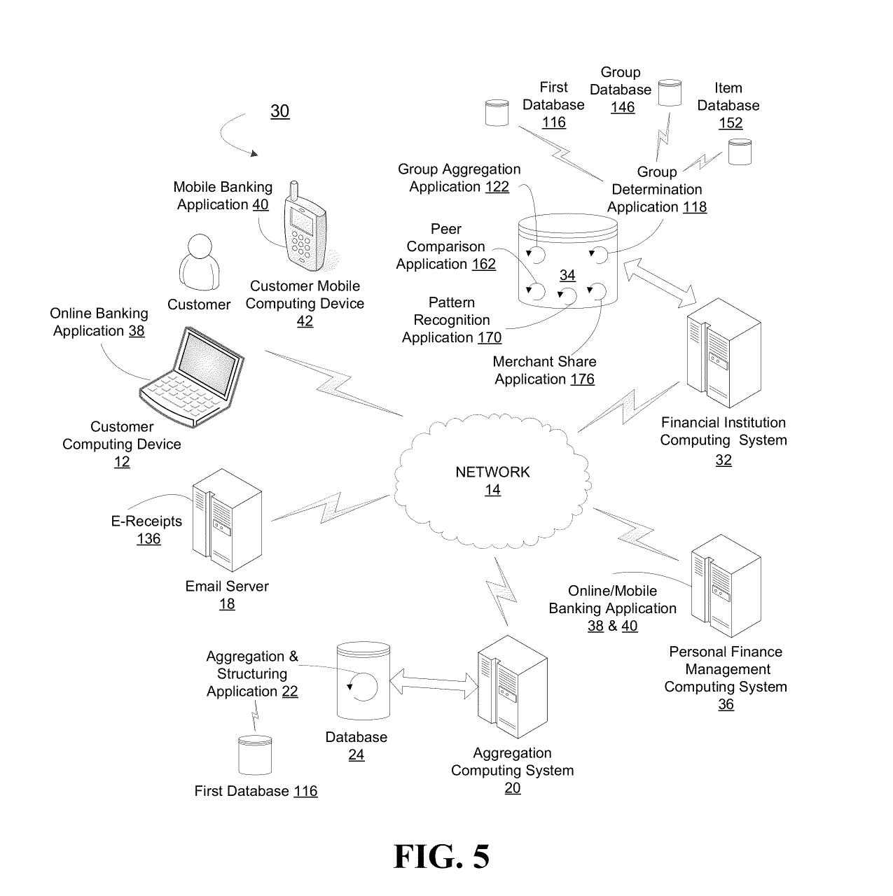

Referring to FIG. 5 a schematic diagram 30 is provided of a computing network environment for implementing embodiments of the present invention. The network 14 which serves as the communication hub may comprise any combination of one or more of the Internet, a wide area network, a local area network, a short range/near field network or any other form of contact or contactless network. The aggregation computing system 20 receives transaction item-identifying data in an unstructured format. The transaction item-identifying data is associated with a transaction including one or more items. In specific embodiments, the transaction item-identifying data are emails, such as e-receipts 136 obtained from crawling email accounts stored on email server 18. The aggregation computing system includes database 24 which stores aggregation and structuring application 22, which is configured to structure the unstructured transaction item-identifying data for financial institution compatibility. Structuring of the data may include parsing the unstructured data using predetermined templates and/or formatting the data to a format compatible with financial institution standards for communication and presentation. Once the data has been properly structured the data may be stored in database 24 or database 116 located on network 14.

Financial institution computing system 32 is in communication with database 34 and stores group determination application 118 that is configured to access the structured transaction item-identifying data in first database 116 to determine that transactions and/or items in the transactions are associated with a group of individuals. In specific embodiments of the invention, the group determination 118 will access group database 154 to compare transaction data, such as the payment account to tables that match payment accounts to groups of individuals and in other embodiments of the invention, the group determination application 118 will access item database 152 to compare item identifying data (e.g., SKUs, UPS or the like) to tables that match items or item types to the group of individuals. The database 34 also includes group aggregation application 122 that is configured to receive the structured transaction item-identifying data associated with the group, aggregate the data and provide individuals in the group access to the aggregated data, such as through aggregated views presented in a financial institution application, e.g., online or mobile banking application.

In optional embodiments of the invention database 34 may store peer comparison application 162 that is configured to determine peer data that comprises aggregated transaction item-identifying data for one or more groups that a similar to another group and provide the peer data to the group in comparison to their aggregated transaction item-identifying data. In this regard individuals can gauge their budgeting performance compared to other similarly situated groups of individuals.

In other optional embodiments of the invention database 34 stores patent recognition application 170 that is configured to determine transaction patterns or item patterns in the aggregated structured item-identifying. Transaction patterns include a series of transaction that include the same or similar items conducted over a predetermined period of time and item patterns include the same or similar items purchased over a predetermined period of time. Transaction and items patterns are instrumental in identifying trends within the group of individuals.

In still other optional embodiments of the invention database 34 includes merchant share application 176 that is configured to communicate at least a portion of the aggregated transaction item-identifying data to one or more predetermined merchants. For example, the data that is communicated may include transaction patterns or item patterns. In turn, the merchant may use the aggregated item-identifying data to determine items or services to offer to the group and, specifically, offer to the group at a group discount.

The environment 30 also includes personal finance management computing system 36 which may include a portion or all of financial institution computing system 32 or may be a separate entity of the financial institution or of a third party is configured to execute personal finance management applications, such as online banking application 38 or mobile banking application 40. The personal finance management application is configured to provide aggregated views of the aggregated data to individuals in the group. Filtering may be provided that is configured to present filtered aggregated views to the individuals based on the data that the individual is authorized to view.

Thus, the present invention as described in detail above, provides for automatically identifying transactions and/or items in a transaction that are associated with a group of individuals, such as a family, co-workers, a special interest group, a demographic group a social network group or the like. Once transactions and/or items in the transaction have been identified as being associated with the group, the transaction data associated with the transactions and/or the items in the transactions is aggregated and aggregated views of the data are made accessible to individuals in the group, such as through a financial institution financial management application, e.g., online or mobile banking application.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more general-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention. While the foregoing disclosure discusses illustrative embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any embodiment may be utilized with all or a portion of any other embodiment, unless stated otherwise.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. An apparatus for aggregating item-level transaction data for a group of individuals, the apparatus comprising:
a computing platform having a memory and at least one processor in communication with the memory device;
an aggregation and structuring application stored in the memory, executable by the processor and configured to receive transaction item-identifying data in an unstructured format, wherein the transaction item-identifying data is associated with transactions including one or items, structure the transaction item-identifying data for financial institution compatibility and store the structured data in a first database;
a group determination application stored in the memory, executable by the processor and configured to access the transaction item-identifying data in the first database to determine that one or more of the transactions are associated with a group of individuals;
a group aggregation application stored in the memory, executable by the processor and configured to receive a plurality of item-identifying data associated with the one or more transactions, aggregate the plurality of item-identifying data and provide the individuals in the group access to the aggregated plurality of item-identifying data.

2. The apparatus of claim 1, wherein the group determination application is further configured to (1) access a group database that associates financial payment accounts to groups of individuals and (2) determine that a financial payment account identifier in the transaction item-identifying data is matched to a financial payment account that is associated with a group of individuals.

3. The apparatus of claim 1, wherein the group determination application is further configured to access the item-identifying data in the first database to determine that one or more items in the one or more transactions are associated with the group of individuals.

4. The apparatus of claim 3, wherein the group determination application is further configured to (1) access an item database that associates at least one of (a) items and (b) types of items to groups of individuals (2) determine that an item identified in the transaction item-identifying data associated with a transaction is matched to one of (a) items or (b) types of items associated with the group of individuals.

5. The apparatus of claim 3, wherein the group aggregation application is further configured to configured to receive a plurality of item-identifying data associated with the items in the transactions determined to be associated with the group of individuals, aggregate the plurality of item-identifying data and provide the individuals in the group access to the aggregated plurality of item-identifying data associated with the items in the transaction determined to associated with the group of individuals.

6. The apparatus of claim 1, wherein the group determination application is further configured to determine that the transactions are associated with the group of individuals, wherein the group of individuals is one of a family, co-workers, a similar-demographic group, a similar-interest group, and a social media group.

7. The apparatus of claim 1, wherein the group aggregation application is included within a budgeting application that is configured to allow the group of individuals to manage budget for the group.

8. The apparatus of claim 1, wherein the group aggregation application is included within an expense reporting and reimbursement application that is configured to provide for managing expense reporting and reimbursement for the group of individuals.

9. The apparatus of claim 1, wherein the group aggregation application is further configured to provide the individuals in the group pre-configured filtered access to the aggregated plurality of item-identifying data, wherein the pre-configured filtered access provides for individuals in the group to access only item-identifying data that an individual in the group has been authorized to access.

10. The apparatus of claim 1, further comprising a peer comparison application that is stored in the memory, executable by the processor and configured to determine peer data for at least one group of individuals similar to the group of individuals and provide the individuals in the group access to the peer data in comparison to the aggregated plurality of item-identifying data associated with the group of individuals.

11. The apparatus of claim 1, further comprising a pattern recognition application that is stored in the memory, executable by the processor and configured to determine, from the aggregated item-identifying data, one of transaction patterns or item patterns for the group of individuals, wherein transaction patterns include a plurality of transactions with similar items and item patterns include similar items.

12. The apparatus of claim 1, a merchant share application that is stored in the memory, executable by the processor and configured to communicate the aggregated plurality of item-identifying data to predetermined merchants, wherein the predetermined merchants use the aggregated plurality of item-identifying data to determine items or services to offer to the group at a group discount.

13. A method for aggregating item-level transaction data for a group of individuals, the method comprising:
receiving, by a computing device processor, transaction item-identifying data in an unstructured format, wherein the transaction item-identifying data is associated with transactions that include one or more items;
structuring, by a computing device processor, the transaction item-identifying data for financial institution system compatibility;
determining, by a computing device processor, that more than one of the transactions are associated with a group of individuals;
aggregating, by a computing device processor, the plurality of item-identifying data associated with the transactions; and
generating, by a computing device processor, an aggregated view of the aggregated plurality of item-identifying data that is accessible to at least one individual in the group of individuals.

14. The method of claim 13, wherein determining that the transactions are associated with a group of individuals further comprises accessing, by a computing device processor, a group database that associates financial payment accounts to groups of individuals and determining, by a computing device processor, that a financial payment account identifier in the transaction item-identifying data is matched to a financial payment account that is associated with a group of individuals.

15. The method of claim 13, wherein determining that the transactions are associated with a group of individuals further comprises determining that one or more items in the one or more transactions are associated with the group of individuals.

16. The method of claim 15, wherein determining that the one or more items in the one or more transactions are associated with the group of individuals further comprises accessing, by a computing device processor, an item database that associates at least one of (a) items and (b) types of items to groups of individuals and determining, by a computing device processor, that an item identified in the transaction item-identifying data associated with the one or more transactions is matched to one of (a) items or (b) types of items associated with the group of individuals.

17. The method of claim 15, wherein aggregating further comprises aggregating, by the computing device processor, the plurality of item-identifying data associated with the one or more items and wherein generating further comprises generating, by the computing device processor, the aggregated view of the aggregated plurality of item-identifying data associated with the items in the transaction determined to associated with the group of individuals.

18. The method of claim 13, wherein generating the aggregated view further comprises generating, by the computing device processor, the aggregated view, wherein the aggregated view is filtered for each individual in the group based on predetermined filtering criteria that defines item-identifying data accessible to a corresponding individual in the group.

19. The method of claim 13, further comprising determining, by a computing device processor, peer data for at least one group of individuals similar to the group of individuals and generating, by a computing device processor, a peer view of the peer data that is presented in in comparison to the aggregated view.

20. The method of claim 13, further comprising determining, by a computing device processor, from the aggregated item-identifying data, one of transaction patterns or item patterns for the group of individuals, wherein transaction patterns include a plurality of transactions with similar items and item patterns include similar items.

21. A computer program product comprising:
a non-transitory computer-readable medium comprising:
a first set of codes for causing a computer to receive transaction item-identifying data in an unstructured format, wherein the transaction item-identifying data is associated with a transaction that includes one or more items;
a second set of codes for causing a computer to structure the transaction item-identifying data for financial institution system compatibility;
a third set of codes for causing a computer to determine that the transaction is associated with a group of individuals;
a fourth set of codes for causing a computer to aggregate the structured item-identifying data associated with the transaction and other structured item-identifying data associated with other transactions determined to be associated with the group of individuals; and
a fifth set of codes for causing a computer to generate an aggregated view of the aggregated item-identifying data that is accessible to at least one individual in the group of individuals.

22. The computer program product of claim 21, wherein the third set of codes is further configured to cause the computer to determine that a financial payment account identifier in the transaction item-identifying data is matched to a financial payment account that is associated with a group of individuals.

23. The computer program product of claim 21, wherein the third set of codes is further configured to cause the computer to determine that one or more items in the one or more transactions are associated with the group of individuals.

24. The computer program product of claim 23, wherein the third set of codes is further configured to cause the computer to determine that an item identified in the transaction item-identifying data associated with the one or more transactions is matched to one of (a) items or (b) types of items associated with the group of individuals.

25. The computer program product of claim 23, wherein the fourth set of codes is further configured to cause the computer to aggregate the plurality of item-identifying data associated with the one or more items and wherein the fifth set of codes is further configured to cause the computer to generating the aggregated view of the aggregated item-identifying data associated with the items in the transaction determined to associated with the group of individuals.

26. The computer program product of claim 21, wherein the fifth set of codes is further configured to generate the aggregated view, wherein the aggregated view is filtered for each individual in the group based on predetermined filtering criteria that defines item-identifying data accessible to a corresponding individual in the group.
